(19) United States
(12) Patent Application Publication
(10) Pub. No.: US 2018/0098195 A1
(43) Pub. Date: Apr. 5, 2018

(54) Methods Circuits Devices Systems and Functionally Associated Computer Executable Code to Support Location Based Services to a Wireless Devices Communicatively Coupled to a Communication Network

(71) Applicant: SAGUNA NETWORKS LTD., Yokneam Illit (IL)

(72) Inventors: Daniel Nathan Frydman, Haifa (IL); Lior Fite, Zurit (IL)

(21) Appl. No.: 15/726,303

(22) Filed: Oct. 5, 2017

Related U.S. Application Data
(60) Provisional application No. 62/404,228, filed on Oct. 5, 2016.

(51) Int. Cl. H04W 4/02; H04L 29/08; H04W 4/14

(52) U.S. Cl. CPC H04W 4/023; H04W 4/14; H04L 67/26

(57) ABSTRACT

The present application discloses methods, circuits, devices, systems and functionally associated computer executable code to support location based services to mobile communication devices (UE) communicatively coupled to wireless communication networks in accordance with embodiments of the present invention. According to some embodiments, push type messages to a UE may include location service related content. UE localization may be performed by server applications having access to only a UE's temporary APN IP address, while network push type messages may be addressed using a permanent device identifier of the UE. A process of UE address to identifier correlation at or near the network core may support location triggered push messaging to the UE.

### PRIORITY CLAIMS

The present application claims the benefit of U.S. Provisional Patent Application 62/404,228 filed Oct. 5, 2016 and U.S. Provisional Patent Application 62/404,228 filed Oct. 5, 2016, the disclosures of which are each incorporated herein by reference in their entirety.

### FIELD OF THE INVENTION

The present invention generally relates to the field of wireless communication. More specifically, the present invention relates to methods, circuits, devices, systems and functionally associated computer executable code to support location based push notifications to wireless communication devices communicatively coupled to a wireless communication network.

### BACKGROUND

Since 2009, when for the first time the volume of data traffic over mobile network exceeded that of voice traffic, mobile data has more or less tripled each year in volume, thus taking over more and more of the mobile traffic in volume. In order to meet demand for low latency data services, Edge computing and Edge computing clouds are becoming part of the mobile network architecture standard.

Mobile communication network Edge computing enables a variety of services, including location based services. Additionally, as new ways of determining or estimating, with good precision, a location of each wireless communication device communicatively coupled to the network becomes possible, new opportunities to provide a wider variety of business oriented location based services are emerging.

Edge Computing solutions, be it Mobile Edge Computing (MEC), Open Edge Computing (OEC), Fog, CORD and Open CORD or any other concept of Software Defined Networking and Virtualization Technology at the edge, present an opportunity to provide new and exciting location based services to end users. The edge solution itself may be able to generate information regarding the location of each specific device on an APN UE IP address level, based on geo location coordinates, Mobile Network Tracking Area, Cell Global Identifier or any other form of location. In addition, such an edge solution may provide relevant location based services, through push notification or other method, to end users, based on their IP addresses, by running dedicated applications, but this will require corresponding installed applications to run on the end device(s). The application must actually receive this data sent through an IP gateway of the system to the device using an impermanent address. Running such locations based services on the Internet will also require a dedicated application to run on the device, enabling the Internet application to detect the specific end device.

Accordingly, there is a need for improved methods and systems to enable providing location based services, through the use of push notifications like SMS or other similar method, to end devices without the use of dedicated application running on the devices.

### SUMMARY OF INVENTION

The present invention includes methods, circuits, devices, systems and functionally associated computer executable code to support location based services for wireless communication devices communicatively coupled to a communication network, such as a cellular communication network.

Aspects of the present invention address a need to support sending relevant information to UE's in relation to their physical location with or without the installation of a dedicated application on the device. UE IP level location information, whether based on a geo location coordinates level, Mobile Network Tracking Area, Cell Global Identifier level or any other form of location information, may be obtained at a communication network edge and passed towards a dedicated network element residing at or near the network core. This core element, may be aware of fixed UE identifiers such as specific MSISDN, IMSI, ACR and/or any other UE identification information of UE's on the network, and may provide mapping information to correlate received UE IP addresses based on APN (Access Point Name). Correlation between impermanent IP address and permanent identifiers may than enable the sending of messages, such as location based service information, in the form of push messages or notification over the network (such as SMS) towards UE's whose IP addresses were identified by a location based service as the Edge of the network. The present invention includes systems and method to providing location based services using a push notification to wireless communication devices UE's independent on the devices having a dedicated application associated with the location based service running on the device.

According to embodiments of the present invention, Edge computing elements, platforms or other solutions deep in the RAN portion of a mobile communication network, at or near a network Edge segment or access segment, may generate location information per each device being served by the edge computing solution, application or service. The specific type of information can vary according to the solution and may include geo location coordinates, Mobile Network Tracking Area, Cell Global Identifier or any other form of location information. This information may be used to generate specific location based services to end devices. As the edge solutions are located in the RAN portion of the network, they usually only have access to IP addresses on an APN level of the devices. IP addresses on an APN level may be available for the detection of each device while specific device identification information of the device (such as MSISDN, IMSI or other) isn't available in the RAN or edge portion of the network. In order to provide dedicated services, including location based services, to a device from information the edge platform residing in the RAN can get and provide, without a dedicated application running on the device, an application residing on the Internet must be aware of the device's permanent identification information—just the device APN level IP address will not suffice.

Accordingly, aspects of the present invention may include a network element located outside the RAN or network edge, also referred to as a central module, in an area of the network at or near the network core, which may communicate with services running on the edge of the network and or with other location based service, and may have access to UE identifier information. This module may also track identification information of each user UE and the APN level IP address allocated to it, by sniffing the relevant control interfaces in the mobile network, or by any other method known today or to be devised in the future. This network element or module may be referred as an UE network address resolving element which is configured to correlate a permanent device identifier of each of one or more EU's, communicatively coupled to a wireless communication node of the network, to the EU's respective current but impermanent APN UE IP level address. The address resolving element may generate and manage a mapping table with information correlating between the UE identifier information and respective device APN level IP addresses.

According to embodiments, edge location based service may communicate towards the central module location information and IP address of a specific device identified or otherwise found within the service's respective coverage are, optionally with additional data or messages content to be provided to a specific device. The central module may identify the specific device and generate a standard message (for example SMS) towards the device including the information received from the edge device, wherein stand message or push message may be forwarded to the device through a network push messaging gateway, such as for example an SMS gateway or a network notification gateway.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a block level network diagram illustrating an exemplary communication network according to embodiments of the present invention including edge computational platforms at the network edge segments and an UE address resolver at or near the core of the network;

FIG. 1B is a data flow level diagram illustrating exemplary data flow between elements at the edge, at the cored and outside the network in accordance with embodiments of the present invention;

FIG. 2 is a functional block diagram of an impermanent UE network address to permanent EU identifier resolver element or module (AKA central module) in accordance with embodiments of the present invention;

FIG. 3A is an information flow diagram showing how a location based service may be provide to a UE communicatively coupled to edge segment of wireless communication network, wherein providing the service includes an ongoing generation of an internal table/DB which matches or correlates between each UE's MSISDN/IMSI/other and the UE's networked assigned APN IP address, in accordance with embodiments of the present invention; and

FIG. 3B is an information diagram illustrating a process of generating specific location based content for a specific UE device at the edge of the network and providing the custom content to the device over the mobile network irrespective of a dedicated application running on the device.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE FIGURES

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid-state memory, magnetic tape, a removable computer diskette, a random access memory (RAM), a read-only memory (ROM), any composition and/or architecture of semiconductor based Non-Volatile Memory (NVM), any composition and/or architecture of biologically based Non-Volatile Memory (NVM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other functionally suitable components may be used.

More specifically, the present invention includes methods, circuits, devices, systems and functionally associated computer executable code to support edge computing on a communication network, such as a wireless access communication network. According to embodiments of the present invention, push type messages to a UE may include location service related content. UE localization may be performed by server applications having access to only application the UE's temporary APN IP address, while network push type messages may be addressed by a permanent device identifier of the UE. A process of UE address correlation at or near the network core may support location triggered push messaging to the UE.

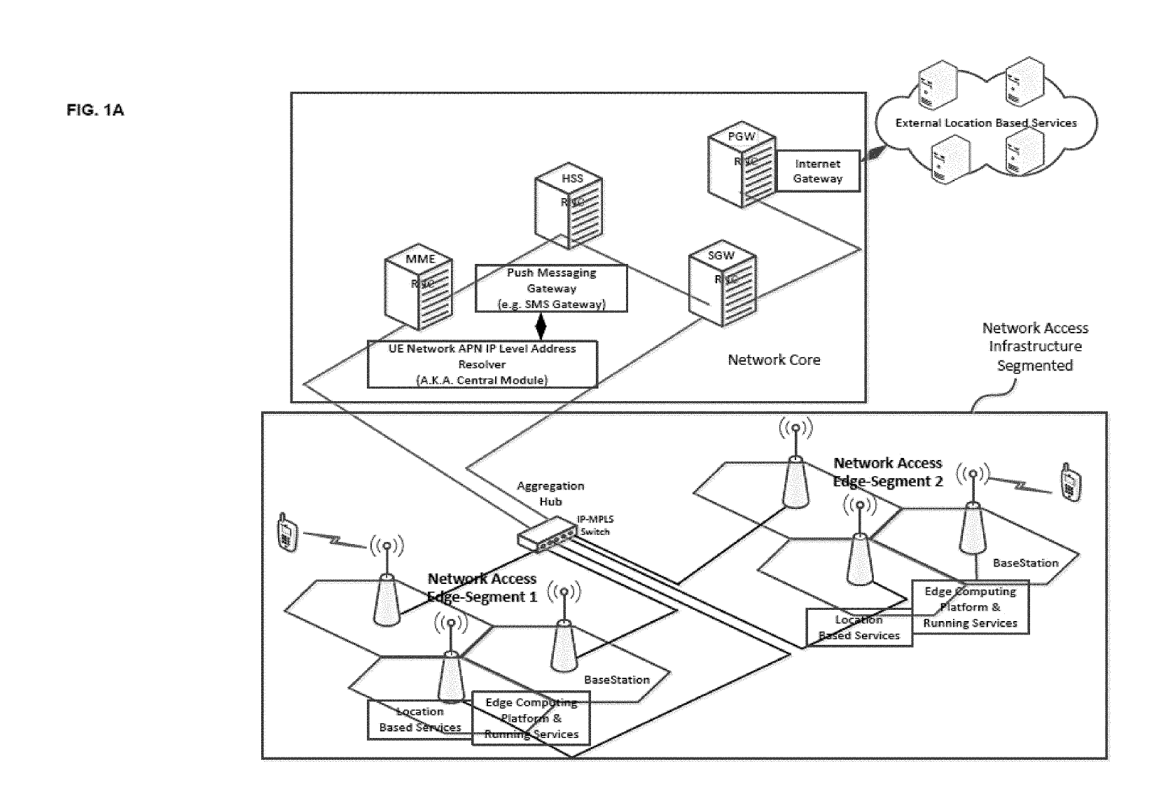

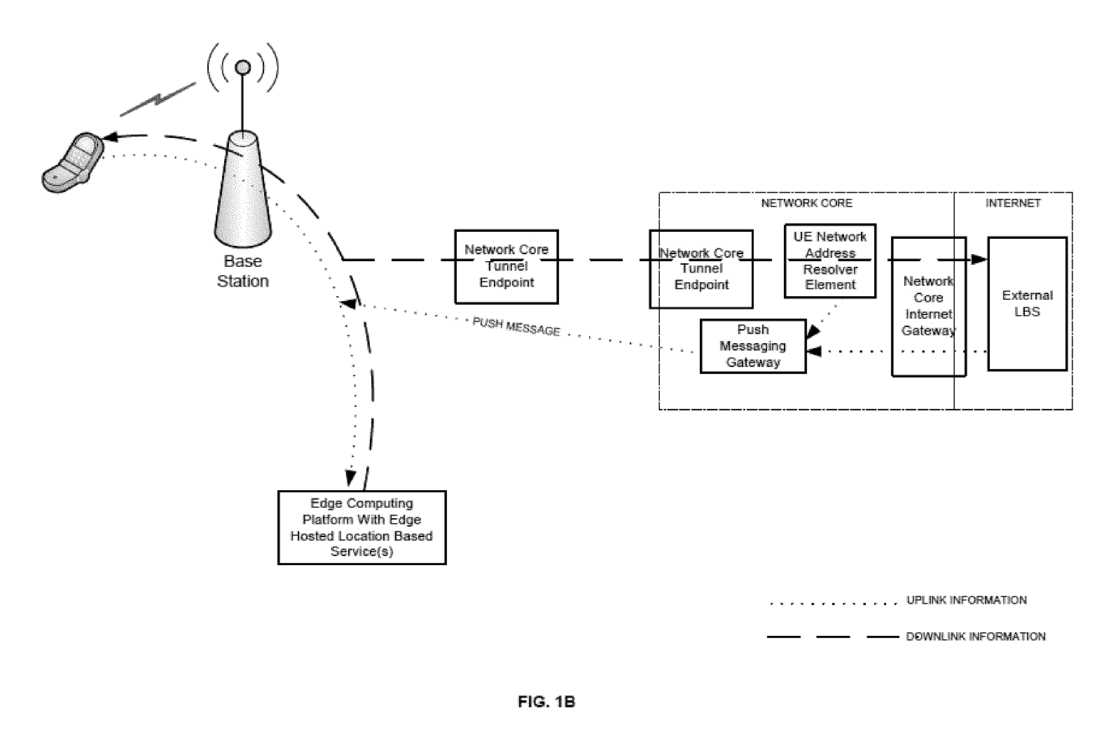

Turning now to FIG. 1A, there is shown a block level network diagram illustrating an exemplary communication network according to embodiments of the present invention including edge computational platforms at the network edge segments and an UE address resolver at or near the core of the network. Also shown are location based service applications or services running both at the network edges and outside the network. Push messaging gateway sends messages to specific UE's communicatively coupled to nodes or access points of the network edge segments with the aid of an address resolver which translates temporary APN IP addresses into device identifiers usable for push messaging or notifications. FIG. 1B is a data flow level diagram illustrating exemplary data flow between elements at the edge, at the cored and outside the network in accordance with embodiments of the present invention for generating a push message to the UE shown.

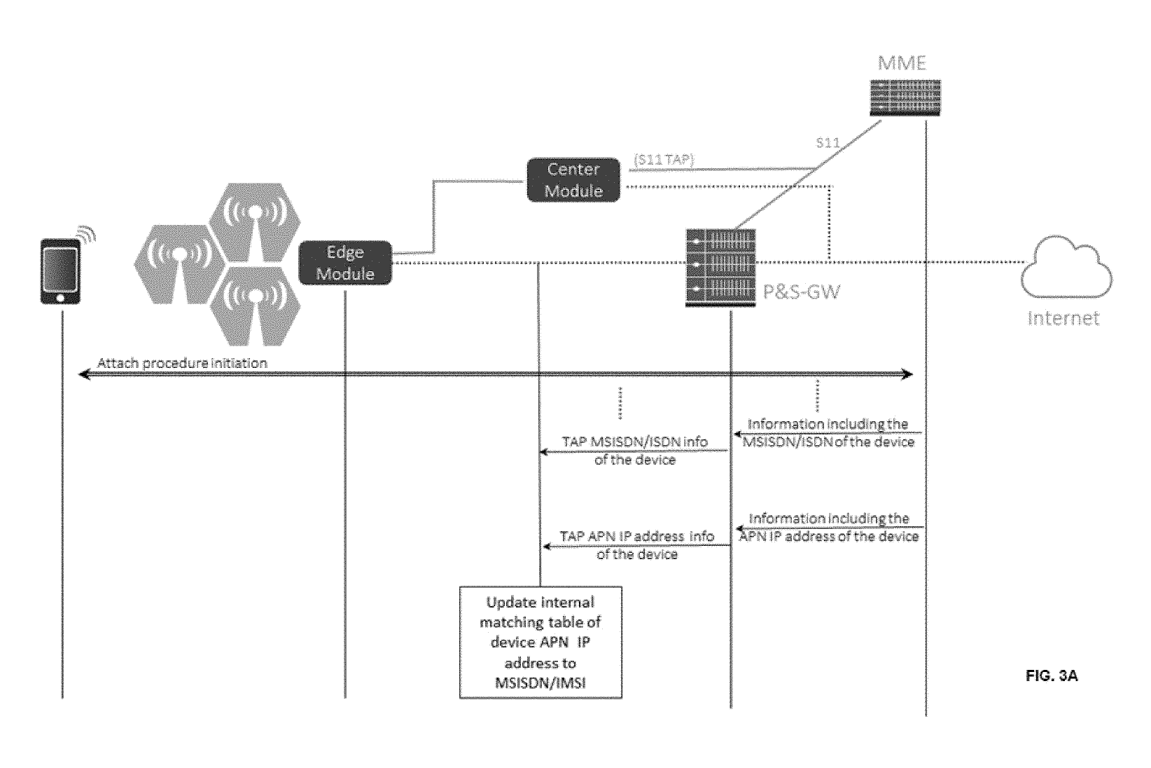

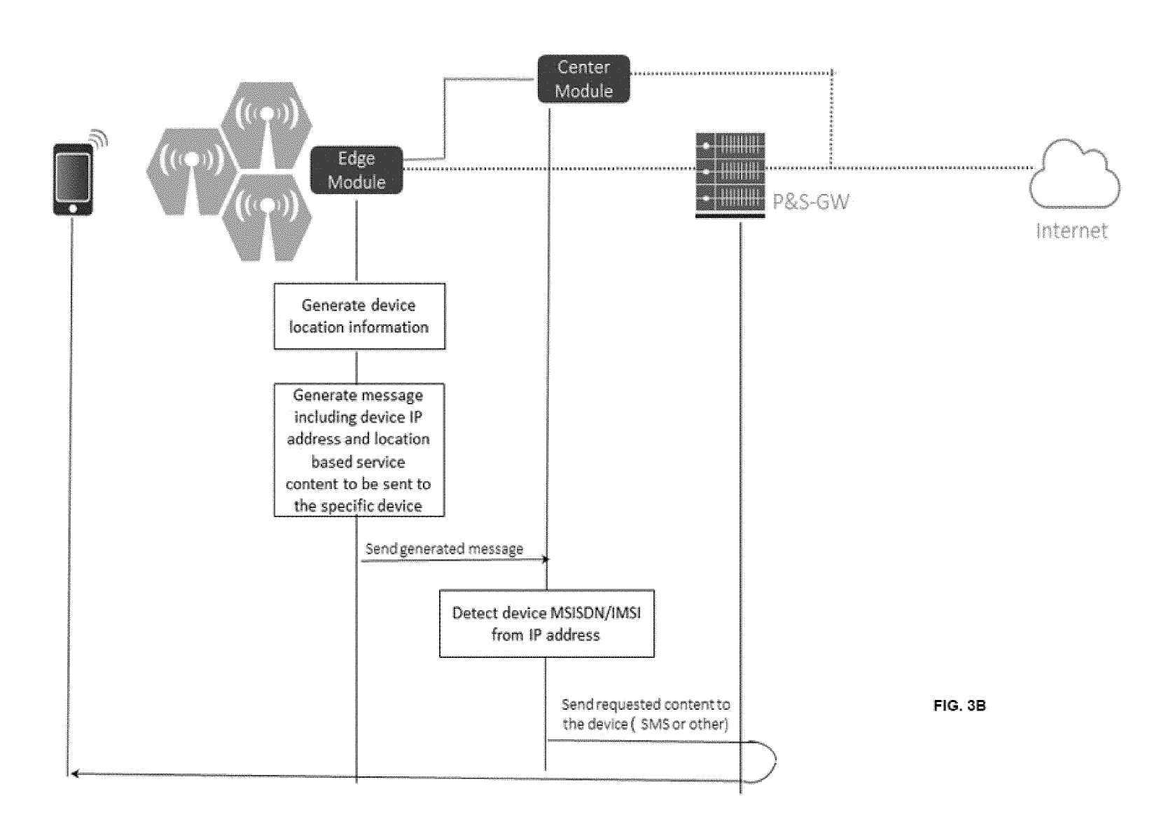

Turning now to FIG. 3A, there is shown an information flow diagram illustrating a process of ongoing generation of an internal table/DB correlating or matching between each UE's MSISDN/IMSI/other identifier and the impermanent APN IP address assigned the device. This takes place for each device that is being communicatively coupled or attached to a network according to the present invention and supported by the suggested solution. Upon disconnecting a specific UE from the network, the specific entry associated with the specific UE may be removed.

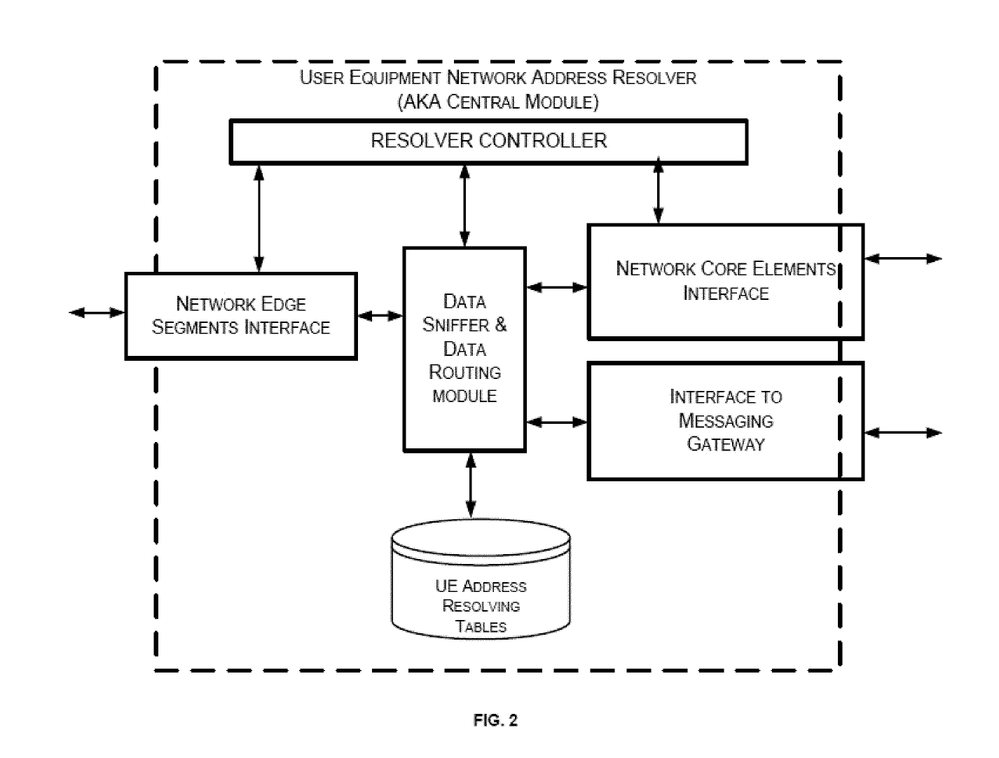

FIG. 2 is a functional block diagram of an impermanent UE network address to permanent EU identifier resolver element or module (AKA central module) in accordance with embodiments of the present invention. The resolved is the network element which generates the DB/table of correlations. It is also the entity which provides the correlation information as need for specific push messaging.

Turning now to FIG. 3B, there is shown a data follow illustration describing the process of generating specific location based content for a specific device at the edge and providing it to the device over the mobile network nondependent on a dedicated application running on the device.

As shown in FIG. 1A, a communication network according to embodiments of the present invention may include at least one network core with one or more network elements to perform each of one or more network management functions and at least one network edge segment with: (a) one or more wireless access nodes, (b) at least one edge computing resource running at least one location based service, and (c) a device localization service configured to: (i) estimate a location of a wireless communicatively device (UE) coupled to one of said one or more wireless access nodes, (ii) detect an APN UE IP level address for the UE, and (iii) convey the location estimate and detected address of the UE to the at least one location based service. The location based service is configured to, responsive to receiving the location estimate and detected address of the UE, generate message content for the UE and to use the generated content, along with the UE's APN UE IP level address, to trigger a push messaging gateway located outside said network access segment to push a message to the UE.

The push messaging gateway may be adapted to send a push message to an UE designated within a push message instruction received at said gateway, which push message includes message content included within the received push message instruction, and wherein a push message to a given UE requires a permanent device identifier of the UE. Accordingly, the network may include a UE network address resolving element configured to correlate a permanent device identifier of each of one or more EU's, communicatively coupled to a wireless communication node of said network, to the EU's respective impermanent APN EU IP level address.

The edge location based service may send a localized UE's APN UE IP level address to said UE network address resolving element and may receive the permanent device identifier for the UE. The permanent device identifier is selected from the group consisting of: (a) MSISDN, (b) IMSI, (c) ACR, and/or any other device identification information which is assigned and programmed into non-volatile memory of the device. The at least one edge location based service may compare said permanent device identifier with a set of stored service recipient profiles indexed by permanent device identifier, and in the event a match is found the edge location based service generates may a custom message based on the matched profile.

According to embodiments, at least one edge location based service uses an EU's impermanent APN UE IP level address to address and send to said push messaging gateway, directly or through another network element, a message push instruction including message content for the UE associated with the impermanent APN UE IP level address. Upon receiving the message push instruction, said push messaging gateway may convert the impermanent APN UE EP level address within the message into a permanent device identifier for the UE designed in the message, and then uses the permanent device identifier to generate and send a network push message to the designated UE with the content in the message push instruction. The push messaging gateway may convert the impermanent APN UE EP level address within the message into a permanent device identifier for the UE designed in the message by accessing said UE network address resolving element or its database/table. UE network address resolving element may be integral or otherwise functionally associated with said gateway.

According to embodiments, the at least one edge location based service may send the generated message content along with the UE's impermeant APN UE IP level address as a message push instruction to said gateway via said UE network address resolving element. The EU network address resolving element may be part of a network appliance, such as a central module, residing outside said network access segment. Upon receiving a push message instruction from said location based service may augment the push message instruction before forwarding part or all of the augmented instruction to said push messaging gateway. Augmentation may include said EU network address resolving element providing a permanent device identifier for the UE corresponding to the impermanent APN EU IP addresses included within the message push instruction received from said at least one location based service.

The network address resolving element may operate by sniffing signaling between communicatively coupled EU's and network management elements on said network in order to generate a mapping table which, for each of one or more UE's communicatively coupled to said network, correlates between a permanent identifier of the UE communicatively coupled to said network and an impermanent APN UE IP address assigned to the UE during by said network. The permanent device identifier may be selected from the group consisting of: (a) MSISDN, (b) IMSI, (c) ACR, and/or any other device identification information which is assigned and programmed into non-volatile memory of the device.

The messaging gateway according to embodiments may be selected from the group consisting of: (a) an sms gateway, (b) a network push notification gateway, and or (c) an operating system notification gateway. The gateway may include unidirectional or bidirectional communication with the resolver element, with the location based service(s) or both.

Functions, operations, components and/or features described herein with reference to one or more embodiments, may be combined or otherwise utilized with one or more other functions, operations, components and/or features described herein with reference to one or more other embodiments, or vice versa. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A communication network comprising:
at least one network core with one or more network elements to perform each of one or more network management functions;
at least one network edge segment including: (a) one or more wireless access nodes, (b) at least one edge computing resource running at least one location based service, and (c) a device localization service configured to: (i) estimate a location of a wireless communicatively device (UE) coupled to one of said one or more wireless access nodes, (ii) detect an APN UE IP level address for the UE, and (iii) convey the location estimate and detected address of the UE to the at least one location based service; and
wherein said location based service is configured to, responsive to receiving the location estimate and detected address of the UE, generate message content for the UE and to use the generated content, along with the UE's APN UE IP level address, to trigger a push messaging gateway located outside said network access segment to push a message to the UE.

2. The communication network according to claim 1, wherein said push messaging gateway is adapted to send a push message to an UE designated within a push message instruction received at said gateway, which push message includes message content included within the received push message instruction, and wherein a push message to a given UE requires a permanent device identifier of the UE.

3. A communication network according to claim 2, further comprising a UE network address resolving element configured to correlate a permanent device identifier of each of one or more EU's, communicatively coupled to a wireless communication node of said network, to the EU's respective impermanent APN EU IP level address.

4. The communication network according to claim 3, wherein said edge location based service sends the UE's APN UE IP level address to said UE network address resolving element and receives the permanent device identifier for the UE.

5. The communication network according to claim 4, wherein said permanent device identifier is selected from the group consisting of: (a) MSISDN, (b) IMSI, (c) ACR, and/or any other device identification information which is assigned and programmed into non-volatile memory of the device.

6. The communication network according to claim 4, wherein said at least one edge location based service compares said permanent device identifier with a set of stored service recipient profiles indexed by permanent device identifier, and in the event a match is found the edge location based service generates a custom message based on the matched profile.

7. The communication network according to claim 1, wherein said at least one edge location based service uses an EU's impermanent APN UE IP level address to address and send to said push messaging gateway, directly or through another network element, a message push instruction including message content for the UE associated with the impermanent APN UE IP level address.

8. The communication network according to claim 7, wherein upon receiving the message push instruction, said push messaging gateway converts the impermanent APN UE EP level address within the message into a permanent device identifier for the UE designed in the message, and then uses the permanent device identifier to generate and send a network push message to the designated UE with the content in the message push instruction.

9. The communication network according to claim 8, wherein said push messaging gateway converts the impermanent APN UE EP level address within the message into a permanent device identifier for the UE designed in the message by accessing said UE network address resolving element.

10. The communication network according to claim 9, wherein said UE network address resolving element is integral or otherwise functionally associated with said gateway.

11. The communication network according to claim 7, wherein said at least one edge location based service sends the generated message content along with the UE's impermeant APN UE IP level address as a message push instruction to said gateway via said UE network address resolving element.

12. The communication network according to claim 11, wherein said EU network address resolving element is part of a network appliance residing outside said network access segment and upon receiving a push message instruction from said location based service augments the push message instruction before forwarding part or all of the augmented instruction to said push messaging gateway.

13. The communication network according to claim 12, wherein augmentation includes said EU network address resolving element providing a permanent device identifier for the UE corresponding to the impermanent APN EU IP addresses included within the message push instruction received from said at least one location based service.

14. The communication network according to claim 3, wherein said network address resolving element sniffs signaling between communicatively coupled EU's and network management elements on said network in order to generate a mapping table which, for each of one or more UE's communicatively coupled to said network, correlates between a permanent identifier of the UE communicatively coupled to said network and an impermanent APN UE IP address assigned to the UE during by said network.

15. The communication network according to claim 3, wherein said permanent device identifier is selected from the group consisting of: (a) MSISDN, (b) IMSI, (c) ACR, and/or any other device identification information which is assigned and programmed into non-volatile memory of the device.

16. The communication network according to claim 3, wherein said messaging gateway is selected from the group consisting of: (a) sms gateway, (b) network push notification gateway, and or (c) operating system notification gateway.

17. A method of providing a location based service to a wireless communication device (UE) communicatively coupled to an access node of an edge segment of communication network, said method comprising:
estimating a location of UE with a coverage area of the network edge segment, detect an APN UE IP level address for the UE, and conveying the location estimate and detected address of the UE to the at least one location based service; and
response to the conveyed information generating message content for the UE and using the UE's APN UE IP level address to trigger a push messaging gateway located outside said network access segment to push a message to the UE.

18. The method according to claim 17, wherein sending a push message to an UE designated within a push message instruction include obtaining a permanent device identifier of the UE.

19. A method according to claim 18, further comprising correlating a permanent device identifier of each of one or more EU's, communicatively coupled to a wireless communication node of the network, to the EU's respective impermanent APN EU IP level address.
